(19) United States
(12) Patent Application Publication
(10) Pub. No.: US 2013/0313833 A1
(43) Pub. Date: Nov. 28, 2013

(54) WATER-POWERED GENERATOR

(71) Applicant: Boo-Hyeon Bang, Gyeongsangnam-do (KR)

(72) Inventor: Boo-Hyeon Bang, Gyeongsangnam-do (KR)

(21) Appl. No.: 13/980,332

(22) PCT Filed: Sep. 6, 2011
(86) PCT No.: PCT/KR2011/006562

§ 371 Date: Jul. 18, 2013

(30) Foreign Application Priority Data
Feb. 18, 2011 (KR) 10-2011-0014691

(51) Int. Cl. F03B 13/10

(52) U.S. Cl. CPC F03B 13/10
USPC 290/54

(57) ABSTRACT

The present invention relates to a water-powered generator comprising: a ship body including side columns arranged at either side thereof and a bottom plate for interconnecting the lower portions of the side columns; a waterwheel which is arranged in the space defined by the side columns and the bottom plate, and the outer surface of which has a chain; steering helms extending downwardly from the bottoms of the side columns; a horizontal rotating shaft, both ends of which are connected to the side columns, respectively, and which has teeth that interlockingly rotate with the chain; and a generator connected to one end of the horizontal rotating shaft and fixed at one end of one of the side columns. The generator receives, via the chain and the teeth, the rotating force from the waterwheel generated by flowing water, and converts the received rotating force into electrical energy.

### CROSS-REFERENCE TO RELATED APPLICATION

This application claims the benefit of Korean Patent Application No. 10-2011-0014691, filed on Feb. 18, 2011 in the Korean Intellectual Property Office, the disclosure of which is incorporated herein by reference.

### TECHNICAL FIELD

The present invention relates to a water-powered generator, and in particular to a water-powered generator which makes it possible to obtain enough strength by providing a side column, a front frame, a rear frame and an upper frame while achieving easier engagement and disengagement work with the aid of a third rope and an anchor.

### BACKGROUND ART

Generally speaking, an electric power generation method may be classified into a nuclear power generation using a nuclear power, a thermal power generation using fossil fuels, a wind power generation which generates electric power using wind as an energy source and a water powered generation.

The above listed electric power generation methods require a huge amount of energy source which is required for driving electric power generation facilities and a large capacity of electric power generation facilities along with some limits in the selections of installation places. In terms of the fossil fuels such as petroleum and coal which are used as an energy source in the thermal power generation, their reserves are very limited, so the continuous use of such fuels may cause some problems such as resource depletions, for which the uses of such fuels are not permanent. In addition, such fuels may cause air pollutions and radiation leak, so they are considered non-environmentally friendly.

In order to prevent the depletion of resource due to the use of petroleum and coal, various disasters the global warming phenomenon which occurs as petroleum or coal is combusted and the environmental pollutions due to various pollutants, there are being developed various power generation methods which are environmentally friendly thanks to the use of natural energy such as wind force, wave force, tidal force, solar heat and water power, and such generation power methods are also directed to permanently using energy sources.

The electric power generation method of converting solar energy or wind force energy into electric energy and storing in batteries is greatly limited by weather and surrounding environments. In addition, since the tidal force based power generation method can generate electric power only when related facilities are installed in a place with a large difference of tides, the installation place is very limited. In case of the wave force based electric power generation, related facilities should be installed in a place where a lot of waves are continuously formed like the tidal generation method, so it also has limitations in terms of the selection of installation places.

In case of the conventional water-powered generator, it needs a lake or a water reservoir in which a lot of water can be stored. Since the above conventional water-powered generator should be installed in the limited places, there also is a limitation in the selection of installation places. In case of the conventional water-powered generator, it is directed to generating electric power by rotating the turbine using a head drop of the water which is stored in a higher place, so it needs to construct a relatively greater facility such as a water reserve facility like dam, a power generation facility generally installed below a dam and a water drain facility which serves to discharge the water used for power generation to river or sea. Therefore, the installations of such facilities require a lot of spaces and cost a lot.

In addition, the conventional water-powered generator cannot operate when water is not enough stored in the reserve facility or when the weather is in the dry season or is drought, so it is impossible to generate enough electric power because the operation efficiency of the electric power generator is low.

### DISCLOSURE OF INVENTION

Accordingly, the present invention is made to resolve the above mentioned problems, and an embodiment of the present invention is directed to a water-powered generator that can be easily moved or anchored by a ship body with the aid of a side column and an anchor for thereby generating, in a structurally stable state, electric power while the water-powered generator is floating on the water.

To achieve the above objects, there is provided a water-powered generator, comprising a ship body which is formed of a side column provided at either side and a bottom plate interconnecting the lower sides of the side column and which floats on water; a waterwheel which is provided in the space made by the side column and the bottom plate and has a chain at an outer surface; a steering rudder which downwardly extends from a lower surface of the side column; a horizontal rotary shaft both ends of which are connected to the side column and which has teeth engaged to the chain and rotating; and a generator which is connected to an end portion of one side of the horizontal rotary shaft and is fixed at one end of the side column, wherein the generator serves to convert the rotational force of the waterwheel generating by the flows of water into electric energy by receiving by way of the chain and the teeth.

According to another embodiment of the present invention, there is provided a water-powered generator, comprising a ship body which includes a side column formed at either side, a bottom plate connecting the lower side of the side column, a water inlet port which protrudes from a front side of the side column and has a space formed at a central portion to engage a waterwheel, the ship body floating on water; a waterwheel which includes a plurality of blades and a rotary shaft at which the plurality of the blades are installed and rotatable, the waterwheel being engaged in a space of the ship body and being rotatable; a generator which is engaged at the ship body so as to generate electric power by receiving rotational force of the waterwheel; and a driving force transfer means which connects the waterwheel and the generator and transfers the rotational force of the waterwheel to the generator.

### ADVANTAGEOUS EFFECTS

According to a first embodiment of the present invention, first, the interior of the side column is hollow, and most of the side column is submerged in water, so it is not influenced by sea wind, by which electric power can be generated in stable state.

Second, a waterwheel can be positioned in the direction of water with the aid of a steering rudder engaged at a lower side of a ship body like a steering rudder of a yacht.

Third, since a generator is driven by a chain provided at a center portion of a waterwheel and teeth provided at a horizontal rotary shaft, an acceleration device formed of a plurality of gears is not used, so the facility does not cost a lot.

Fourth, a blade of a waterwheel is provided with an assistant blade. In case of a heaving sea, it is backwardly folded for thereby preventing the central blade from being damaged, so the durability of generation system can be enhanced.

Fifth, an anchoring and a disengagement are easy thanks to the uses of an anchor and a third rope, so the moving and fixing work time of a water-powered generator by a ship body can be saved.

Sixth, the water-powered generator can operate in normal state even when there is a strong typhoon or a heaving sea in such a way that a front frame, a rear frame and an upper frame are constructed in a stable structure.

Seven, the surface of a water-powered generator is coated with a rust inhibitor, so the rusting on the same can be prevented.

Eight, the interior of the blade is hollow; the waterwheel can be prevented from sinking into water.

Ninth, the end portions of a horizontal support shaft and a vertical support shaft are slanted; the flow of water is not interrupted.

Ten, the front side and the rear side of the side column are shape same, so when water is inputted through either a front side or a rear side, electric power generation is possible.

Eleventh, when there is strong wind like typhoon, the assistant blade is rotated so as to prevent the input of the water into the waterwheel for thereby protecting the waterwheel.

### BRIEF DESCRIPTION OF DRAWINGS

FIG. 1 is a perspective view illustrating a water-powered generator according to a first embodiment of the present invention.

FIG. 2 is a view illustrating a ship body and a frame of a water-powered generator of FIG. 1.

FIG. 3 is a view illustrating an anchor and a rope of a water-powered generator of FIG. 1.

FIG. 4 is a cross sectional view illustrating a waterwheel of a water-powered generator of FIG. 1.

FIG. 5 is a perspective view illustrating a water-powered generator according to a second embodiment of the present invention.

FIG. 6 is a side view illustrating a water-powered generator according to a second embodiment of the present invention.

FIG. 7 is a front view illustrating a water-powered generator according to a second embodiment of the present invention.

FIG. 8 is a plane view illustrating a water-powered generator according to a second embodiment of the present invention.

### BEST MODES FOR CARRYING OUT THE INVENTION

The water-powered generator according to the preferred embodiments of the present invention will be described with reference to the accompanying drawings. It is noted that the thickness of the lines of the drawings and the size of the elements might be exaggerated for classification and convenience in understanding the present invention.

The terms employed in the present invention are defined in consideration of their functions and can be defined in different ways based on the intentions of a user or an operator in accordance with the typical practices, so it needs to correctly define such terms throughout the detailed descriptions of the present invention.

The following embodiments of the present invention are provided not for limiting the scope of the present invention, but for providing illustrative matters on the elements recited in claims of the present invention, and they include the technical concepts of the specification of the present invention and the elements which can be substituted with equivalents, and it is obvious that the embodiments thereon belong to the scope of the present invention.

### First Embodiment

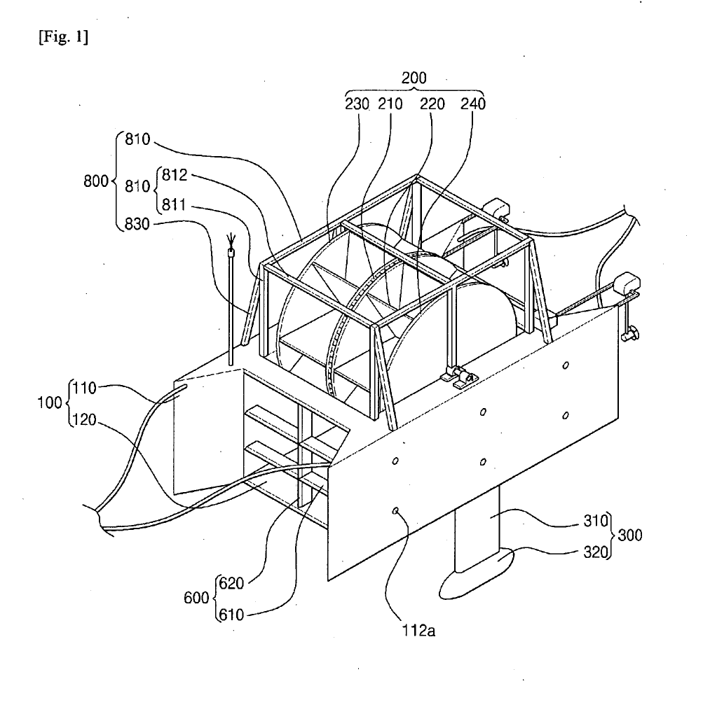

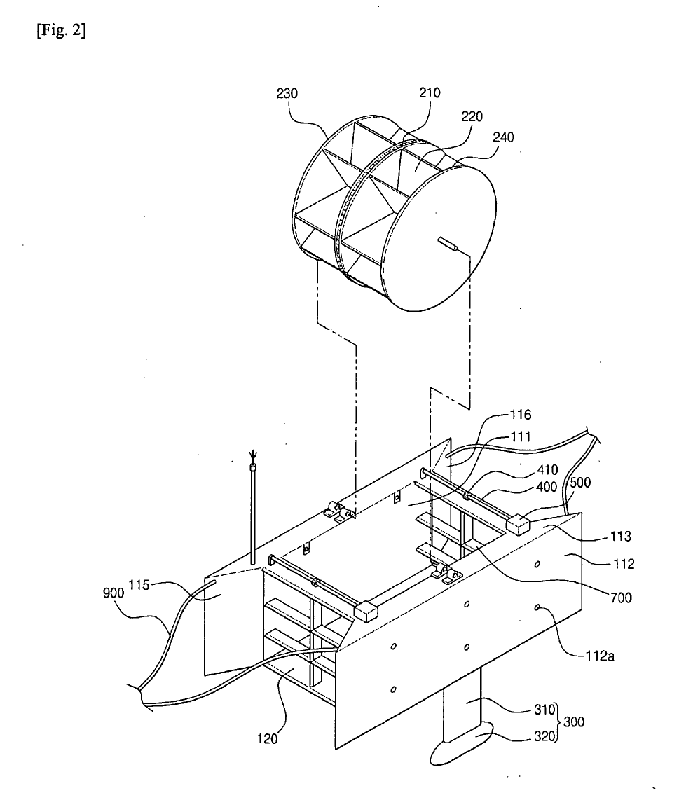

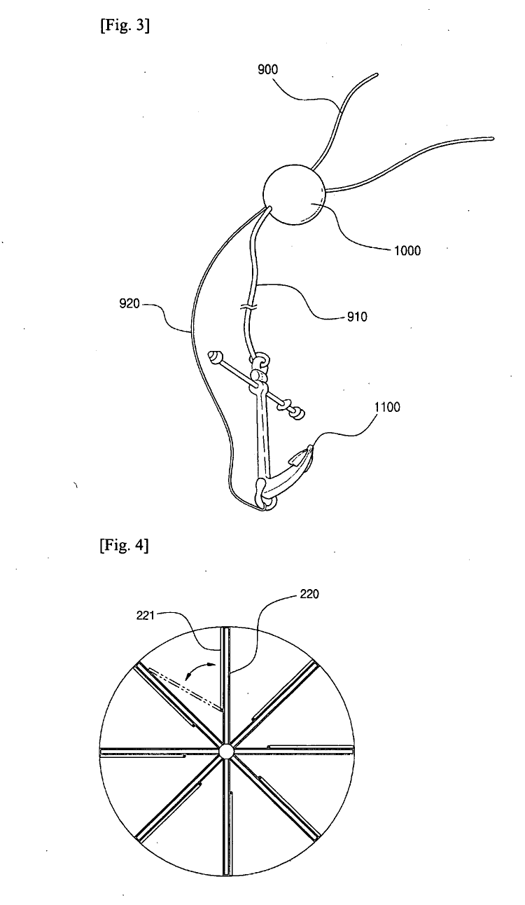

FIG. 1 is a perspective view illustrating a water-powered generator according to a first embodiment of the present invention. FIG. 2 is a view illustrating a ship body and a frame of a water-powered generator of FIG. 1. FIG. 3 is a view illustrating an anchor and a rope of a water-powered generator of FIG. 1. FIG. 4 is a cross sectional view illustrating a waterwheel of a water-powered generator of FIG. 1.

The water-powered generator according to a first embodiment of the present invention comprises a ship body 100 which is formed of a side column 110 provided at either side and a bottom plate 120 interconnecting the lower sides of the side column 110 and which floats on water; a waterwheel 200 which is provided in the space made by the side column 110 and the bottom plate 120 and has a chain 210 at an outer surface; a steering rudder 300 which downwardly extends from a lower surface of the side column 110; a horizontal rotary shaft 400 both ends of which are connected to the side column 110 and which has teeth 410 engaged to the chain 210 and rotating; and a generator 500 which is connected to an end portion of one side of the horizontal rotary shaft 400 and is fixed at one end of the side column 110. The generator 500 serves to convert the rotational force of the waterwheel 200 generating by the flows of water into electric energy by receiving by way of the chain 210 and the teeth 410.

As shown in FIG. 1, the water-powered generator according to the present invention comprises a ship body 100, a waterwheel 200, a steering rudder 300, a horizontal rotary shaft 400 and a generator 500.

The ship body 100 comprises a side column 110 and a bottom plate 120 and is movable by a main structure.

The side column 110 is provided at either side of the ship body 100, and the side columns 110 of either side are line-symmetrically about the central line of the ship body 100. The interiors of the side columns 110 are hollow, so the ship body can have certain required buoyancy.

The lower side of the side column 110 is connected by the bottom plate 120, and a waterwheel 200 is provided in a space “S” made by the side column 110 and the bottom plate 120. The waterwheel 200 is in whole made in a circular column shape and has a chain 210 surrounding the side surfaces of the waterwheel 200.

The ship body 100 can float on water with the aid of the buoyancy that the side column 110 and the bottom plate 120 have, and when water is inputted into the waterwheel 200 while the ship body 100 is moving or is anchoring, the waterwheel 200 rotates as a typical waterwheel is rotated by water.

A steering rudder 300 is provided at the lower side of the side column 110, and the steering rudder 300 serves to maintain the flowing direction of water like a typical rudder.

The waterwheel 200 rotates, and there is provided a horizontal rotary shaft 400 which has teeth 410 engaged with the chain 210 and rotates. Either side of the horizontal rotary shaft 400 is connected to the side column 110. An end portion of one side of the horizontal rotary shaft 400 is connected to the generator 500, and as the horizontal rotary shaft 400 rotates, the generator 500 rotates.

The generator 500 is fixed at one end of the side column 110 and serves to convert the rotational force of the waterwheel 200 generated by flowing water into electric energy by receiving by way of the chain 210 and the teeth 410. The present invention uses the chain 210 and the teeth 410, so additional acceleration device is not required, so the system does not cost a lot, and a simple structure can be made.

As show in FIG. 1, the generator 500 can be provided at a front end and a rear end of the side column 110. In this case, the generation capacity can be doubled thanks to the rotations of the waterwheel.

The side column 110 comprises an inner surface 111; an outer surface 112 having a surface area wider than the inner surface 111; an upper surface 113 interconnecting the upper sides of the inner surface 111 and the outer surface 112; a lower surface 114 interconnecting the lower sides of the inner surface 111 and the outer surface 112; a front slant surface 115 interconnecting the front side corners of the inner surface 111 and the outer surface 112; and a rear slant surface 116 interconnecting the rear side corners of the inner surface 111 and the outer surface 112, and a plurality of holes 112a are formed at the outer surface 112.

As shown in FIG. 2, the side column 110 comprises an inner surface 111, an outer surface 112, an upper surface 113, a lower surface 114, a front slant surface 115 and a rear slant surface 116.

Here, the inner surface 111 and the outer surface 112 are parallel to each other and are vertically arranged. The surface area of the outer surface 122 is wider than the inner surface 111. When interconnecting the front side corners of the inner surface 111 and the outer surface 112, a front slant surface 115 is formed, and when connecting the rear side corners of the inner surface 111 and the outer surface 112, a rear slant surface 116 is formed.

Consequently, when water is inputted from the front side or the rear side owing to the front slant surface 115 and the rear slant surface 116, as water enters, the cross section area decreases, and the inflow speed of the water increases, so the water can be naturally inputted along the front slant surface 115 and the rear slant surface 116.

The upper surface 113 interconnects the upper sides of the inner surface 111 and the outer surface 112, and the lower surface 114 interconnects the lower sides of the inner surface 111 and the outer surface 112.

A plurality of holes 112a is formed at the outer surface 112. Water flows into the interior of the hollow side column 110, and the side column 110 is submerged, so the system is not influenced by sea wind for thereby obtaining a stable power generation.

There are provided a front frame 600 having a plurality of horizontal support shafts 610 connecting an end portion of a front side of the inner surface 111 and a vertical support shaft 620 which upwardly extends from the bottom plate 120 and interconnects the horizontal support shafts 610, and a rear frame 700 having a plurality of horizontal support shafts 610 connecting an end portion of a rear side of the inner surface 111 and a vertical support haft 620 which upwardly extends from the bottom plate 120 and connects the horizontal support shaft 610. The end portions of the horizontal support shaft 610 and the vertical support shaft 620 are slanted.

As shown in FIG. 2, there are provided a front frame 600 and a rear frame 700.

The front frame 600 is formed of a plurality of horizontal support shafts 61 connecting an end portion of a front side of the inner surface 111 and a vertical support shaft 620 which upwardly extends from the plurality of the horizontal support shafts 610 and the bottom plate 120 and interconnects the horizontal support shafts 610, the whole structure of which is formed in a lattice structure.

The rear frame 700 is made same as the front frame 600.

The end portions of the horizontal support shaft 610 and the vertical support shaft 620 are slanted, by which the inflow of water has less resistance.

As the speed of inflow water gradually increases when water flows in along the front slant surface 115 and the rear slant surface 116, it needs to install the front frame 600 and the rear frame 700 for the purpose of structurally stabilizing the ship body 100.

There is provided an upper frame 800 which comprises a plurality of protrusion pieces 810 having an extension piece 811 extending from an inner side of the upper surface 113 and a left and right connection piece 812 connecting the end portion of the extension piece 811, a front and rear connection piece 820 connecting the upper end portions of the extension pieces 811, and a slant piece 830 extending from an upper end portion of the extension piece 811 to an outer end portion of the upper surface 113.

As shown in FIG. 2, there is provided an upper frame 800.

The upper frame 800 includes a protrusion piece 810, a front and rear connection piece 820 and a slant piece 830.

The protrusion piece 810 includes an extension piece 811 and a left and right connection piece 812.

The extension piece 811 upwardly extends from the inner side of the upper surface 113 and is connected by the left and right connection piece 812.

The front and rear connection piece 820 connects the upper end portions of the plurality of the extension pieces 811.

The slant piece 830 interconnects the upper end portion of the extension piece 811 and the outer end portion of the upper surface 113.

There may further be provided a front and rear connection piece 820 interconnecting a plurality of left and right connection pieces 812 or there may be further provided a left and right connection piece 812 connecting the inner side of the upper surface 113.

Even though water flows into the remaining portions except for the front frame 600 and the rear frame 700 by means of the upper frame 800, enough strength can be obtained, which results in a structurally stable construction of the ship body 100.

The waterwheel 200 comprises a blade 220 which rotates by the water flowing in through the front frame 600 or the rear frame 700; a horizontal central shaft preventing the rattles of the blade 220; a left plate 230 placed at the left side of the blade 220; and a right plate 240 placed at the right side of the blade 220.

The blade 220 is formed of a plurality of straight plates which extend in radial directions from the horizontal central shaft and are hollow, and there is provided a chain 210 between the left plate 230 and the right plate 240 for connecting the end portion of the blade 220.

As shown in FIG. 4, the waterwheel 200 comprises a blade 220, a horizontal central shaft, a left plate 230 and a right plate 240.

The water flowing in through the blade 220 rotates the horizontal central shaft. The blade 220 is formed in a straight plate shape, and the blade 220 is made of a plurality of thin plates which extend from the horizontal central shaft and are arranged at regular intervals.

It is preferred that the interior of the blade 220 is made vacuum, so the waterwheel 200 is not submerged underwater for thereby obtaining a reliable rotation of the waterwheel 200.

The right plate 240 and the left plate 230 serve to prevent the left and right movements of the blade 220 and are made in the same shape.

Both ends of the horizontal central shaft are inserted into the bearing formed at an end of the side column 110.

A plurality of rollers is provided between the left plate 230 and the side column 110 and between the right plate 240 and the side column 110. Here, the rollers serves to prevent the left and right movements of the left plate 230 and the right plate 240 as a lot of water flows in, and even when the left plate 230 and the right plate 240 come into contact with the side column 110, a reliable rotation of the waterwheel 200 can be secured.

A chain 210 connecting the ends of the blade 220 is provided between the left plate 230 and the right plate 240. As shown in FIG. 2, an intermediate plate may be provided at an intermediate portion between the left plate 230 and the right plate 240, and a chain 210 may be provided at an outer surface of the intermediate plate. An intermediate band connecting the ends of the blade 220 can be provided instead of the intermediate plate. A chain may be provided at an outer surface of the intermediate band.

The steering rudder 300 comprises a rod 310 which extends from the lower surface to the lower side 114 and is flat, and an adjusting piece 320 which is provided an end portion of the rod 310 and is wider than the rod and is lower than the rod.

As sown in FIG. 1, the steering rudder 300 comprises a rod 310 and an adjusting piece 320.

The rod 310 is prolonging in a longitudinal direction and is flat.

The adjusting piece 320 is wider than the rod 310 and is lower in its height.

The waterwheel 200 can be positioned in the flowing direction of water with the aid of the steering rudder 300. Here, a proper number of the waterwheels 200 is provided.

There are provided a first rope 900 which extends from the front slant surface 115 or the rear slant surface 116; a weight 1000 provided at an end portion of the first rope 900; a second rope 910 which extends from the weight 1000; an anchor 1100 which is formed at an end portion of the second rope 910; and a third rope 920 which extends from a lower end of the anchor 1100, and the anchor 1100 moves down as the second rope 910 and the third rope 920 are pulled.

As shown in FIG. 3, there are provided a first rope 900, a weight 1000, a second rope 910, an anchor 1100 and a third rope 920.

Here, the first rope 900 extends from the front slant surface 115 and the rear slant surface 116 of both sides and is connected to the weight 1000. The intermediate portion or the lower side of the front slant surface 115 and the rear slant surface 116 is submerged underwater, so it is preferred that the first rope 900 extends from the front slant surface 115 or the rear slant surface 116.

One end of the weight 1000 is connected to the first rope 900, and the other end is connected to the second rope 910.

The anchor 1100 is connected to the second rope 910.

When the system is moved by the main structure and is anchored at a place where a lot of water can flow in, the anchor 1100 is lowered, and the ship body 100 is positioned on water

The third rope 920 is connected to a lower end of the anchor 1100, and the third rope 920 is connected to the weight 1000. When the anchor 1100 is fixed by the second rope 910, there may be a problem in which the releasing work of the anchor 1100 is not easily performed when pulling only the second rope 910. Meanwhile, unlike the second rope 910, when the third rope 920 the lower end of which is connected to the anchor 1100 is pulled at the same time as the second rope 910 is pulled, the anchor 1100 receive the force in two directions, so the anchor 1100 can easily depart. In other words, the anchor 1100 can be easily departed in a direction, as the third rope 920 is pulled in the direction different from the second rope 910 while the second rope 910 is pulled.

As show in FIG. 3, the anchor 1100 comprises a support shaft, and an extension shaft which extends from the lower end of the support shaft and has an acute angle with respect to the support shaft. The anchor 1100 can be planted deeper into the bottom of water since the support shaft and the extension shaft are formed with acute angles.

There is further provided an assistant blade 221 which extends from an end of the blade 220 and is rotatable.

As shown in FIG. 4, the assistant blade 221 extends from the intermediate portion of the blade 220.

The assistant blade 221 remains contacted with the blade 220 at normal times, but when there is strong wind like typhoon, it keeps rotating until it comes into contact with the neighboring blade 220, for thereby preventing the inflow of a lot of water. The assistant blade 221 is hinged and extended to the blade 221 and prolongs, and at the end of the blade 220 is provided an engaging hook for the assistant blade 221 to rotated and to be hooked. At the end of the assistant blade 221 is provided an engaging ring which is hooked by the engaging hook.

It is preferred that the present invention comprises a lightening rod.

The lightening rod extends from the upper surface 113 of the side column 110 for thereby preventing damages by inducing an impact current of lightening into water. Electricity conducts into water along a conductor connected to the lightening rod.

An emergency lamp is provided at an end of the lightening rod.

The emergency lamp can be also used so as to indicate the position of the water-powered generator at night or in emergency.

An outdoor motor may be provided at the front side of the front slant surface 115 or the rear side of the rear slant surface 116. The outdoor motor is engaged to the propeller, so the ship body can move to a set position with the id of the rotational force of the propeller.

When the system is anchored with the anchor 1100, the ship body 100 is positioned in the direction that wind blows in. The ship body 100 can be moved to a more accurate position using the outdoor motor and the steering rudder 300.

It is preferred that the ship body 100 is coated with a rust inhibitor for preventing the rusting of the ship body 100. It is preferred that a mesh net is installed around the ship body 100 so as to prevent the inputs of impurities except for water so as to save maintenance cost because It needs to periodically clean the water-powered generator.

### Second Embodiment

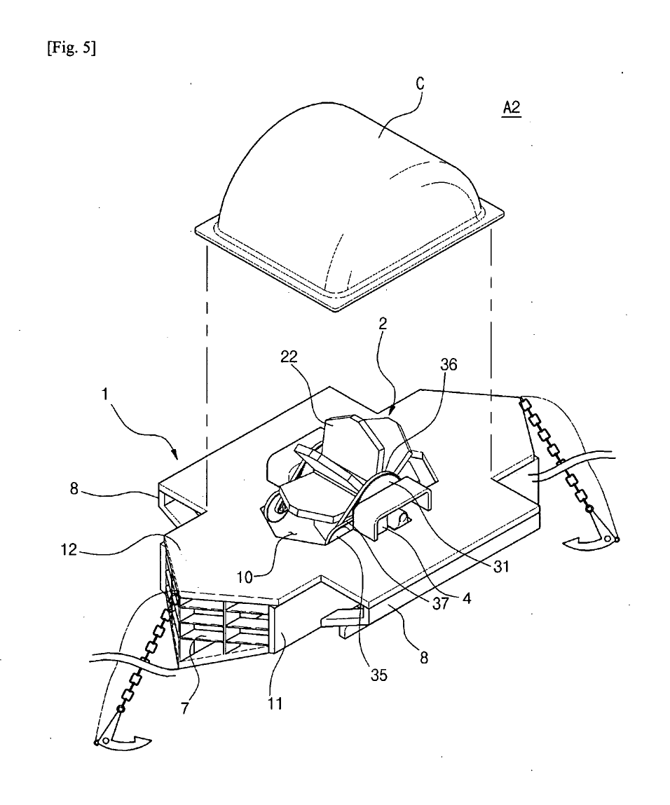

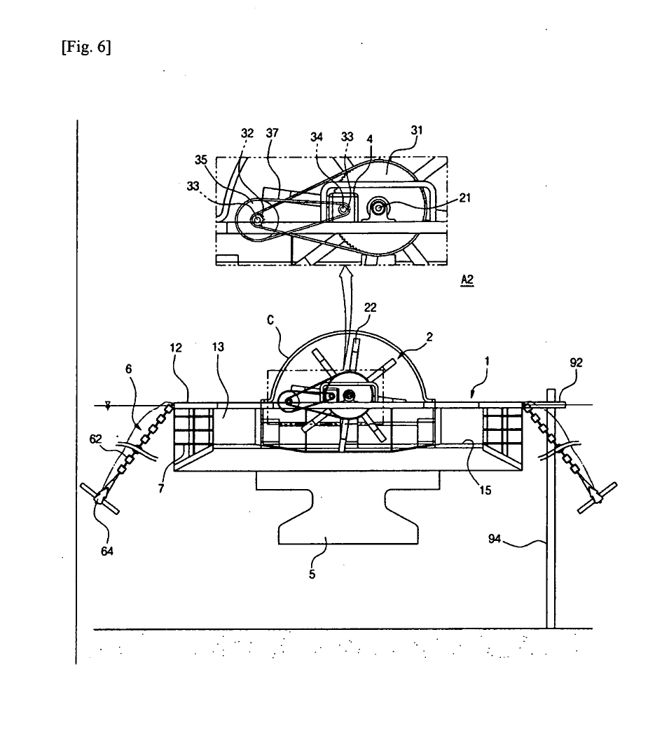

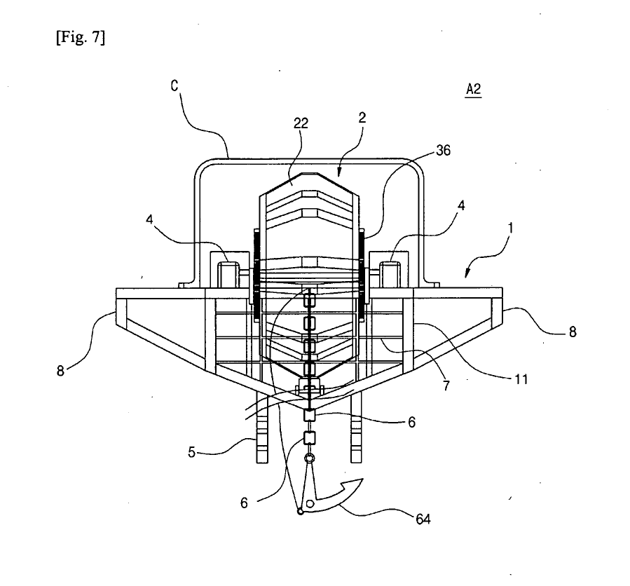

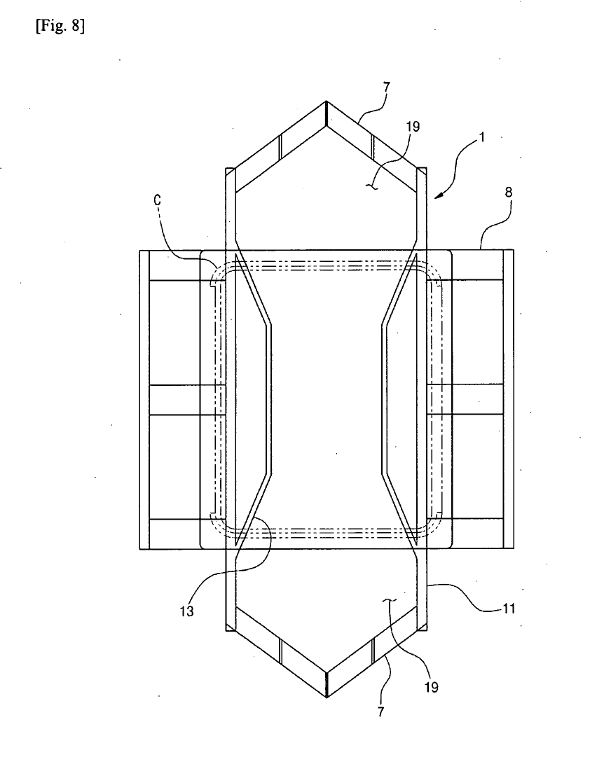

FIG. 5 is a perspective view illustrating a water-powered generator according to a second embodiment of the present invention. FIG. 6 is a side view illustrating a water-powered generator according to a second embodiment of the present invention. FIG. 7 is a front view illustrating a water-powered generator according to a second embodiment of the present invention. FIG. 8 is a plane view illustrating a water-powered generator according to a second embodiment of the present invention.

As shown in FIGS. 5 to 8 the water-powered generator “A2” according to a second embodiment of the present invention comprises:

a ship body 1 which includes a side column 13 formed at either side, a bottom plate 15 connecting the lower side of the side column 13, a water inlet port 19 which protrudes from a front side of the side column 13 and has a space 10 formed at a central portion to engage a waterwheel 2, the ship body floating on water;

a waterwheel 2 which includes a plurality of blades 22 and a rotary shaft 21 equipped with the plurality of the blades 22 and is engaged in a space 10 of the ship body 1 and is rotatable;

a generator 4 which is engaged at the ship body 1 so as to generate electric power by receiving rotational force of the waterwheel 2; and

a driving force transfer means which connects the waterwheel 2 and the generator 4 and transfers the rotational force of the waterwheel 2 to the generator 4; and

a cover “C” which is engaged at the top of the ship body 1 and covers the waterwheel 2, the generator 4 and the driving force transfer means.

An extension plate 11 with a certain length is attached to the side columns 13 of both sides belonging to the ship body 1, and the upper plate 12 is attached so as to cover the top of the extension plate 11.

In addition, at the water inlet port 19 formed by the extension plate 11 and the upper plate 12 is provided an obstacle removing device 7 so as to prevent obstacles or impurities from entering.

The obstacle removing device 7 includes water flowing holes as a plurality of partitions are attached in horizontal and vertical directions.

The obstacle removing device 7 is equipped with an alarming device so as to generate alarm signals immediately when an obstacle is caught for a worker to recognize and remove.

At the lower center portion of the ship body 1 is provided a center board 5 so as to obtain a minimum movement.

The center board 5 is formed in a plate shape with a certain area surface, the intermediate portion of which being inwardly concaved.

At the front and rear sides of the ship body 1 is respectively engaged a position fixing means 6, so the ship body 1 can be fixed at a set position when it floats on water with the aid of the position fixing means 6.

An embodiment of the position fixing means 6 comprises front and rear steel chains 62 engaged at the front and rear ends of the ship body 1, and an anchor 64 attached to the lower sides of the front and rear steel chains 62.

One of the front and rear steel chains 62 is adjusted to have enough releasable length, so the ship body 1 can swing against waves, thus preventing damages.

Another embodiment of the position fixing means 6 comprises a bracket 92 which is provided with a certain length at the front and rear sides of the ship body 1 and has a through hole at an end portion of the same; and a guide rod 94 which is vertically engaged to the through hole of the bracket 92 and is fixed at an underwater surface.

At a place where water is sallow, it is more proper to plant and fix the guide rod 94 into the bottom of underwater sea rather than to fix with an anchor.

As the guide rod 94 is vertically installed, the ship body 1 can ascend and descend as the water level rises or lowers, so it is possible to stably maintain a set position even when there is a change in water level.

At both surfaces of the ship body 1 is provided a horizontal state maintaining part 8 for the ship body 1 to float on water and to keep a horizontal state.

The horizontal state maintaining part 8 is formed in a box shape, the box being hollow, with its lower surface being slanted and having a buoyancy, so the ship body 1 can float on water maintaining a balanced horizontal state.

The driving force transfer means comprises a first sprocket 31 which is provided at a side portion of the waterwheel 2 and is engaged to the rotary shaft 21; a first driven shaft 33 which is engaged at a side of the space 10 of the ship body 1; a second sprocket 32 which is engaged to the first driven shaft 33 and is connected to the first sprocket 31 through a chain 36; a first pulley 35 which is engaged to the first driven shaft 33; and a second driven shaft 34 which is provided at the other side of the space of the ship body 1 and has a second pulley 36 connected to the first pulley 35 though a belt 37 and is connected to the generator 4.

The first sprocket 31 and the first pulley 35 have the same diameters, and the rotation ratio of the first sprocket 31 and the first pulley 25 is 1:1.

Therefore, when the waterwheel 2 rotates, the rotary shaft 21 rotates, and the first sprocket 31 rotates, and the second sprocket 32 connected to the first sprocket 31 through the chain 36 rotates.

The first driven shaft 33 with the second sprocket 32 rotates, and the first pulley 35 engaged at the first driven shaft 33 rotates.

The second pulley 36 connected to the first pulley 35 through the belt 37 rotates, and the second driven shaft 34 with the second pulley 36 rotates for thereby driving the generator 4.

Since the rotational force of the waterwheel 2 is transferred to the generator 4 by way of the driving force transfer means through the above mentioned driving force transfer procedures, so it is converted into electric energy.

At least one generator 4 can be installed at one side of the ship body 1.

As shown in FIG. 7, there are provided a left generator 4 driven by the driving force transfer means provided at the left surface of the waterwheel 2, and a right generator 4 driven by the driving force transfer means provided at the right surface of the waterwheel 2.

As the generators 4 provided at left and right sides are concurrently driven by means of the rotations of the waterwheel 2, electric energy can be produced, and power generation increases.

A plurality of blades 22 are arranged in radial directions at the rotary shaft 21, and the waterwheel 2 rotates by means of the flows of waves, and the rotary shaft 21 and the first sprocket 31 are rotated, so the rotational force of the waterwheel 2 can be transferred to the generator 4 through the driving force transfer means.

An outdoor motor (not shown) is engaged at a rear side of the ship body 1 for the sake of sailing with a self-generated driving force, so the system can be moved to a desired position.

The outdoor motor is a kind of the engine attached to a stern of a small sized boat and is formed of an engine and a propeller, the constructions of which are a known art, so the descriptions thereof will be omitted.

A lightening rod is provided at the top of the ship body 1 so as to prevent lightning, and an emergency alarm lamp is installed at front and rear sides or at left and right sides of the ship body 1 for thereby preventing a collision accident with ships which sail at night.

A lifeboat is provided in the ship body 1 for the sake of accident prevention, and the anchor is engaged at both sides of the ship body for thereby obtaining a minimum movement even when the system faces strong waves or winds like in typhoon.

### INDUSTRIAL APPLICABILITY

The water-powered generator according to the preferred embodiments of the present invention can be well applied to electric power generation industry related to water force, tidal force and wave force.

1. A water-powered generator, comprising:
a main body which is formed of a side column provided at either side and a bottom plate interconnecting the lower sides of the side column and which floats on water;
a waterwheel which is provided in the space made by the side column and the bottom plate and has a chain at an outer surface;
a steering rudder which downwardly extends from a lower surface of the side column;
a horizontal rotary shaft both ends of which are connected to the side column and which has teeth engaged to the chain and rotating; and
a generator which is connected to an end portion of one side of the horizontal rotary shaft and is fixed at one end of the side column, wherein the generator serves to convert the rotational force of the waterwheel generating by the flows of water into electric energy by receiving by way of the chain and the teeth.

2. The water-powered generator of claim 1, wherein the side column comprises:
an inner surface;
an outer surface which is spaced apart from an inner surface and has a surface area wider than the inner surface;
an upper surface interconnecting the upper sides of the inner surface and the outer surface;
a lower surface interconnecting the lower sides of the inner surface and the outer surface; a front slant surface interconnecting the front side corners of the inner surface and the outer surface; and
a rear slant surface interconnecting the rear side corners of the inner surface and the outer surface, and a plurality of holes are formed at the outer surface.

3. The water-powered generator of claim 2, wherein there are provided a front frame having a plurality of horizontal support shafts connecting an end portion of a front side of the inner surface and a vertical support shaft which upwardly extends from the bottom plate and interconnects the horizontal support shafts, and a rear frame having a plurality of horizontal support shafts connecting an end portion of a rear side of the inner surface and a vertical support shaft which upwardly extends from the bottom plate and connects the horizontal support shaft, and the end portions of the horizontal support shaft and the vertical support shaft are slanted.

4. The water-powered generator of claim 3, wherein there is provided an upper frame which comprises a plurality of protrusion pieces having an extension piece extending from an inner side of the upper surface and a left and right connection piece connecting the end portion of the extension piece, a front and rear connection piece connecting the upper end portions of the extension pieces, and a slant piece extending from an upper end portion of the extension piece to an outer end portion of the upper surface.

5. The water-powered generator of claim 3, wherein the waterwheel comprises a blade which rotates by the water flowing in through the front frame or the rear frame; a horizontal central shaft preventing the rattles of the blade; a left plate placed at the left side of the blade; and a right plate placed at the right side of the blade, and the blade is formed of a plurality of straight plates which extend in radial directions from the horizontal central shaft and are hollow, and there is provided a chain between the left plate and the right plate for connecting the end portion of the blade.

6. The water-powered generator of claim 5, wherein the steering rudder comprises a rod which extends from the lower surface to the lower side and is flat, and an adjusting piece which is provided an end portion of the rod and is wider than the rod and is lower than the rod.

7. The water-powered generator of claim 6, wherein there are provided a first rope which extends from the front slant surface or the rear slant surface; a weight provided at an end portion of the first rope; a second rope which extends from the weight; an anchor which is formed at an end portion of the second rope; and a third rope which extends from a lower end of the anchor, and the anchor moves down as the second rope and the third rope are pulled.

8. The water-powered generator of claim 5, wherein there is further provided an assistant blade which extends from an end of the blade and is rotatable.

9. A water-powered generator, comprising:
a ship body which includes a side column formed at either side, a bottom plate connecting the lower side of the side column, a water inlet port which protrudes from a front side of the side column and has a space formed at a central portion to engage a waterwheel, the ship body floating on water;
a waterwheel which includes a plurality of blades and a rotary shaft equipped with the plurality of the blades, the waterwheel being engaged in a space of the ship body and being rotatable;
a generator which is engaged at the ship body so as to generate electric power by receiving rotational force of the waterwheel; and
a driving force transfer means which connects the waterwheel and the generator and transfers the rotational force of the waterwheel to the generator.

10. The water-powered generator of claim 9, wherein an extension plate with a certain length is attached to the side column, and an upper plate part is attached so as to cover the upper side of the extension plate for thereby forming a water inlet port, and an obstacle removing device is provided at the water inlet port for blocking the inputs of obstacles or impurities.

11. The water-powered generator of claim 10, wherein the obstacle removing device is connected to a plurality of partition in horizontal and vertical directions and has a plurality of water flow holes.

12. The water-powered generator of claim 11, wherein the obstacle removing device comprises an alarming device which detects obstacles.

13. The water-powered generator of claim 9, wherein a center board is provided at a lower center portion of the ship body for thereby minimizing the movements.

14. The water-powered generator of claim 9, wherein a position fixing means is engaged at the front and rear portions of the ship body, so the ship body can be fixed when it floats on water.

15. The water-powered generator of claim 14, wherein the position fixing means comprises:
front and rear steel chains which are engaged at the front and rear ends of the ship body; and
an anchor which is attached to a lower side of the front or rear steel chain, and at least one between the front and rear steel chains keeps loosened.

16. The water-powered generator of claim 14, wherein the position fixing means comprises:
a bracket which is provided at the front and rear sides of the ship body and has a through hole at an end portion of the same; and
a guide rod which is vertically engaged to the through hole of the bracket and is fixed at an underwater surface.

17. The water-powered generator of claim 9, wherein the ship body has a horizontally balancing part at both sides which makes the ship body remain horizontal as it floats on water.

18. The water-powered generator of claim 17, wherein the horizontally balancing part is a hollow box shape, the lower side of which being slanted.

19. The water-powered generator of claim 9, wherein the driving force transfer means comprises:
a first sprocket which is provided at a side portion of the waterwheel and is engaged to the rotary shaft;
a first driven shaft which is engaged at a side of the space of the ship body;
a second sprocket which is engaged to the first driven shaft and is connected to the first sprocket through a chain;
a first pulley which is engaged to the first driven shaft; and
a second driven shaft which is provided at the other side of the space of the ship body and has a second pulley connected to the first pulley though a belt and is connected to the generator.

20. The water-powered generator of claim 19, wherein the first sprocket and the first pulley have same diameters.

21. The water-powered generator of claim 9, wherein the ship body is equipped with at least one generator, and the generator comprises a left generator which is driven by a driving force transfer means provided at the left surface of the waterwheel, and a right generator which is driven by a driving force transfer means provided at a right side of the waterwheel.

22. The water-powered generator of claim 9, wherein an outdoor motor is provided at a rear side of the ship body for the sake of sailing.

23. The water-powered generator of claim 9, wherein the ship body is equipped with a lightening rod so as to prevent lightening, an emergency lamp to prevent collision accident, and a lifeboat.

24. The water-powered generator of claim 2, wherein there are provided a first rope which extends from the front slant surface or the rear slant surface; a weight provided at an end portion of the first rope; a second rope which extends from the weight; an anchor which is formed at an end portion of the second rope; and a third rope which extends from a lower end of the anchor, and the anchor moves down as the second rope and the third rope are pulled.

25. The water-powered generator of claim 3, wherein there are provided a first rope which extends from the front slant surface or the rear slant surface; a weight provided at an end portion of the first rope; a second rope which extends from the weight; an anchor which is formed at an end portion of the second rope; and a third rope which extends from a lower end of the anchor, and the anchor moves down as the second rope and the third rope are pulled.

26. The water-powered generator of claim 4, wherein there are provided a first rope which extends from the front slant surface or the rear slant surface; a weight provided at an end portion of the first rope; a second rope which extends from the weight; an anchor which is formed at an end portion of the second rope; and a third rope which extends from a lower end of the anchor, and the anchor moves down as the second rope and the third rope are pulled.

27. The water-powered generator of claim 5, wherein there are provided a first rope which extends from the front slant surface or the rear slant surface; a weight provided at an end portion of the first rope; a second rope which extends from the weight; an anchor which is formed at an end portion of the second rope; and a third rope which extends from a lower end of the anchor, and the anchor moves down as the second rope and the third rope are pulled.
